(19) United States
(12) Patent Application Publication
(10) Pub. No.: US 2004/0243428 A1
(43) Pub. Date: Dec. 2, 2004

(54) Automated compliance for human resource management

(76) Inventors: Steven C. Black, Mendon, UT (US); John P. Boggs, El Granada, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/848,809

(22) Filed: May 19, 2004

Related U.S. Application Data
(60) Provisional application No. 60/474,044, filed on May 29, 2003.

(51) Int. Cl. G06F 17/60

(52) U.S. Cl. 705/1

(57) ABSTRACT

Web-based systems and methods that facilitate the management of human resources and drive employer compliance with applicable statutes, laws, rules, regulations in areas such as hiring practices, employee discipline, employee transfers and termination, employee training, pay status, employee compensation and benefits. Client forms are provided by a server and are continuously updated consistent with changes in the applicable laws and regulations that correspond to human resources processes, such that the client always obtains current versions of the necessary employee forms from the server. The employee forms are also presented to the client in a sequence that is determined at least in part by legal criteria and the needs of the client to further ensure compliance with the rules of law.

### CROSS-REFERENCE TO RELATED APPLICATIONS

This application claims the benefit of U.S. Provisional Application No. 60/474,044, entitled “WEB BASED SYSTEMS AND METHODS FOR HUMAN RESOURCES COMPLIANCE MANAGMENT,” filed on May 29, 2003, which is incorporated herein by reference.

### BACKGROUND OF THE INVENTION

1. Field of the Invention

The present invention relates to systems and methods, implemented in the form of software applications, that facilitate the management of human resources and, more particularly, for automating human resources processes in compliance with rules of law.

2. Related Technology

Human resources managers and other personnel are presently faced with an increasingly complex, and ever-changing, web of rules, statutes, regulations and other guidelines with which they must either comply, or else face potentially costly and time-consuming legal action. The ability of a company or business, and its personnel, to fully and timely comply with the various rules, statutes, regulations and guidelines that apply to human resources management is significantly compromised by the complexity of those statutes and regulations, as well as by the fact that legislation constantly changes the rules with which businesses must comply. Employee turnover, retirement, training and other dynamic events also contribute to the number of processes that must be continually addressed by the human resources personnel.

In businesses characterized by high turnover, the human resources workload can be quite significant. In particular, a substantial amount of documentation is required to manage and track the transition of employees through the application, training and termination processes. One difficulty with managing human resources includes the production and distribution of employee forms, particularly when it is necessary to ensure that forms have been updated according to the latest rules and regulations.

Changes in the law can also create a burden on human resources departments, even beyond the initial requirement to become aware of the changes in the law. In particular, changes in the law can also result in financial loss to a business. For example, changes in the law necessitate training to learn the new laws, the acquisition of new forms and documents, as well as updating the existing processes and procedures.

In these cases, as well as in cases where there is little change in employee turnover or the state of the law, ensuring compliance with human resources rules, statutes, regulations and guidelines can still be difficult to manage because it is often relegated to a relatively low position in terms of the priorities of the business, either intentionally or accidentally. As explained above however, the failure of a business to comply with the applicable human resources laws and regulations can expose the business to significant legal liability.

Nevertheless, despite the importance of compliance with human resources rules and regulations, as well as the potentially significant costs and risks associated with non-compliance, many companies and businesses lack a method or process to systematically identify and address human resource issues implicated by the hiring, termination, training, compensation, and other processes, of the company.

Yet another problem that plagues human resources departments is the difficulty of ensuring that employees are fairly compensated for their work, while at the same time ensuring that the employees are not overcompensated at the expense of the company. It can be difficult, however, to calculate the appropriate compensation for an employee, such as within the sales industry, when the employee is rewarded with special incentives, beyond their base pay, for meeting goals or achieving certain levels of performance.

In many sales positions, for example, the calculations required to determine the regular rate of pay, to see whether an employee is overtime exempt, must account for the special incentives an employee receives, in addition to their base pay. Accordingly, depending on the rules of law and the particular performance of an employee, it might be better for a business to compensate an employee with a salary, instead of paying them based on an hourly rate. Nevertheless, because it can be difficult for a business to determine both what is required by law, and what is best for the business, employees are often compensated too much or too little, thereby exposing the business to potential financial losses and/or legal risks.

### BRIEF SUMMARY OF AN EXEMPLARY EMBODIMENT OF THE INVENTION

The present invention is directed to methods and systems, implemented in the form of software applications that can help resolve the foregoing problems and concerns. In general, the present invention provides web-based systems and methods that facilitate the management of human resources and help drive and contribute to employer compliance with applicable statutes, laws, rules, regulations and policies in areas such as, but not limited to, hiring practices, employee discipline, employee transfers and termination, employee training, pay status, employee compensation and benefits such as vacation, medical leave, and health and life insurance.

To this end, embodiments of the invention are configured to limit the likelihood of deviation from a defined ideal process pathway. More particularly, embodiments of the invention are configured to include or reference, and develop outputs that conform to, applicable human resources rules, statutes, regulations and guidelines. Subscribers are notified when such rules or regulations have changed, but such changes typically require little or no action on the part of the subscriber, as the subscription service is automatically updated to accommodate such changes. Thus, the subscriber can be assured that actions specified by the subscription service in regard to human resources issues are always in compliance with the applicable human resources rules, statutes, regulations and guidelines. Accordingly, the human resources overhead costs of the subscriber can be substantially reduced, as will the likelihood that the subscriber will run afoul of the governing laws and regulations. The savings thus realized in terms of times and money can then be redirected to other aspects of the business.

Exemplarily, aspects of the application are implemented in connection with a subscription service that is accessible by one or more clients by way of a service provider internet site. However, it will be appreciated that aspects of the invention can also be implemented as stand-alone software packages that are suitable for installation on one or more computers. More generally, the application may be implemented in any form consistent with the functionality disclosed herein and with the requirements of the applicable business model.

Accordingly, embodiments of the invention can be implemented in virtually any type or size of business operation. One exemplary implementation of the invention, discussed in detail below, is adapted for use in connection with the auto dealer industry. However, the scope of the invention should not be construed to be so limited. Rather, embodiments of the invention may be employed in any application where the functionality and features disclosed herein would prove useful and desirable.

According to one aspect of the invention, client needs for managing human resources includes a need for employee forms which are provided by a server system through a network connection such as the Internet, for example. The employee forms are continuously updated in compliance with changes in the applicable laws and regulations that correspond to the forms, such that the client always obtains current version of the employee forms from the server. To further ensure compliance with the rules of law, the employee forms are presented to the client in a sequence that is determined at least in part by the rules of law and the needs of the client. Subsequent changes in the law initiate a notice to the client regarding the changes and a suggested course of action to remain in a state of compliance.

According to yet another aspect of the invention, the compensation for an employee is calculated according to a plurality of different standards, such as an hourly base pay standard as well as a salary base pay standard, while accounting for such things as special incentives and overtime. It can then be determined which of the standards should be used to compensate the employee at a fair rate, and within the rules of the law.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one embodiment of a network environment in which client systems can obtain data from a server system that is configured to leverage third party resources;

FIG. 2 illustrates a flowchart of a method for managing human resources compliance involving employee forms that are generated and updated for a client and that are presented to the client in an appropriate order;

FIG. 3 illustrates a flowchart of a method for managing human resources compliance involving the hiring of an employee; and

FIG. 4 illustrates a flowchart of a method for managing human resources compliance involving the compensation of an employee.

### DETAILED DESCRIPTION OF EXEMPLARY EMBODIMENTS

The present invention relates to business methods and systems for managing human resources and, more particularly, for automating the compliance of human resources processes to dynamic and static legal criteria.

Embodiments of the invention are implemented in the form of various software applications, that facilitate the management of human resources and help to drive, and ensure, employer compliance with applicable statutes, laws, rules, regulations and policies in areas such as, but not limited to, hiring practices, employee discipline, employee transfers and termination, employee training, pay status, employee compensation and benefits such as vacation, medical leave, and health and life insurance.

Embodiments of the invention can include special purpose and general-purpose computing devices having various computer hardware and software. The embodiments within the scope of the present invention can also include computer-readable media for carrying or having computer-executable instructions or data structures stored thereon. Computer-executable instructions comprise, for example, instructions and data which cause a general purpose computer, special purpose computer, or special purpose processing device to perform a certain function or group of functions.

Computer-readable media, on the other hand, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means or modules in the form of computer-executable instructions or data structures and which can be accessed by a general purpose or special purpose computer.

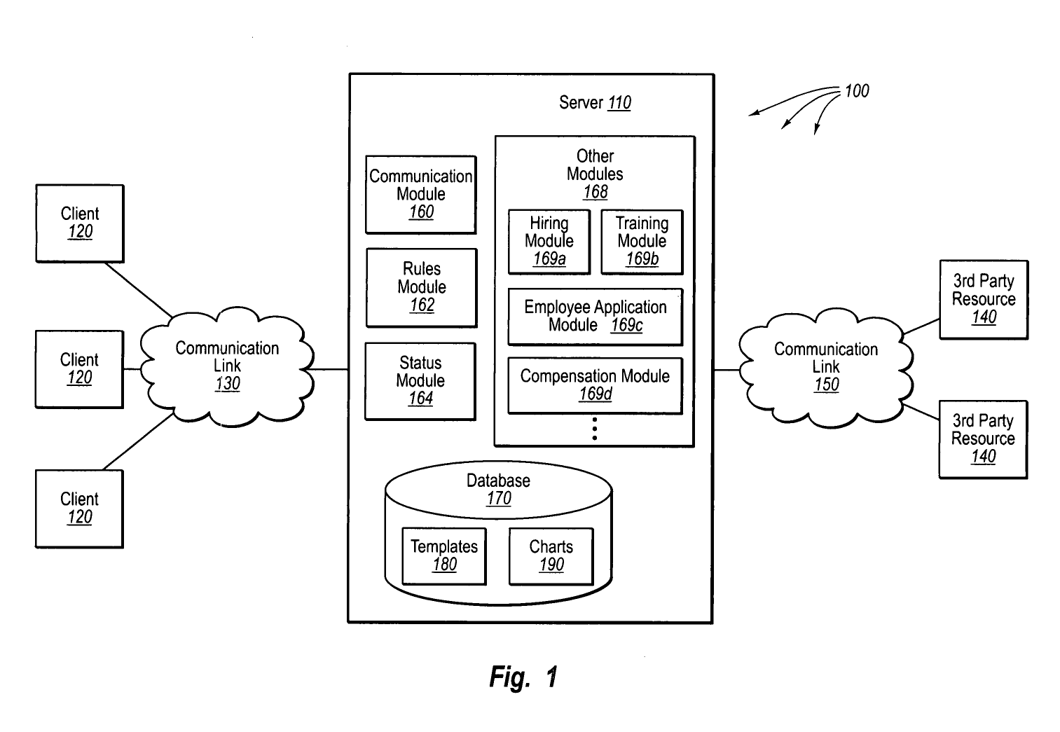

When information is transferred or provided over a network connection (either hardwired, wireless, or a combination of hardwired or wireless) to a computer, the computer also views the network connection as a computer-readable medium. Combinations of the above should also be included within the scope of computer-readable media. Accordingly, communications links 130 and 150, described below in reference to FIG. 1 can also be considered computer-readable media.

Network Environment

Attention will now be directed to FIG. 1, which illustrates a network environment 100 in which embodiments of the invention can be practiced. As shown, a server system 110 is connected with one or more clients 120 through a communication link 130. The communication link 130 can include any combination of hardwired and wireless connections. According to one embodiment, the communication link includes the Internet, such that the one or more client systems 120 can access the server 110 through the Internet.

The server 110 is also shown to be connected with one or more third party resources 140 through an appropriate communication link 150. The third party resources 140 can include any combination of computing devices and network systems. According to one embodiment, the third party resources can include repositories of rules and rules changes, as well as agencies, such as investigative agencies that can be used to perform and/or report the results of a background check or screening process. Third party resources can also include such things as labor insurance, health insurance and safety program providers.

In other embodiments, the client(s) 120 are also configured to communicate directly with the third party resource(s) 140 through an appropriate communication link. In such embodiments, the server 110 can still provide useful functionality by facilitating compliance with existing rules of law and for instructing the client(s) 120 how and when it is appropriate to contact the third party resource(s) 140.

As shown, the server 110 includes various modules (160, 162, 164, 168) and a database 170 that can be used to help manage human resources compliance at the client systems 120.

Each of the illustrated modules (160, 162, 164, 168), although described as corresponding to a particular subject area, also includes the ability to communicate with, and operate in connection with, one or more of the other modules. For example, data or results outputs from one module may comprise inputs to one or more different modules. Moreover, alternative or other functional modules 168 can be plugged into the system as necessary to suit changing needs and requirements. In addition, the functionalities disclosed herein may be allocated in various ways among the functional modules and/or between the server and one or more clients. Accordingly, the allocation of functionalities disclosed herein is exemplary only and is not intended to limit the scope of the invention in anyway.

The first illustrated module, the communication module 160, is configured with suitable computer-executable instructions for enabling communications with the client systems and the third party resources. Accordingly, the communications module 160 can include both hardwired and wireless communications components to enable communication over hardwired networks, as well as wireless networks. The communication module 160 can also include any other components that may be necessary to enable communication with the client systems 120 and third party resources 140, including, but not limited to OCR (optical character recognition), voice recognition and translation components.

The communications module 160 also includes functionality for authenticating and authorizing access to information stored by the server, as well as for encrypting data transmissions. According to one embodiment, the communications module 160 also includes functionality for enabling and authenticating digital signatures of clients and client employees, which may be required to verify requested consent and approval, and/or to execute a legal document.

The rules module 162 includes computer-executable instructions for managing and tracking the legal criteria and other guidelines that are to be complied with by the client systems 120. According to one embodiment, the rules module 162 is configured to actively initiate a query from a third party resource to determine the current state of the law regarding a particular process. The rules module 162 can also include corresponding calendaring functionality for determining the appropriate time to initiate a query for updates in the law, such as, for example, based on a predetermined period of time or occurrence of an event.

In other embodiments, the rules module 162 is configured to passively receive input regarding legal criteria and other guidelines with which the client systems 120 are to comply. The rules module 162 tracks the current state of the law and other legal criteria in a chart 190, table and/or other data structures within the server database 170.

Changes in the law that are received by the rules module 162 can then be incorporated into the templates 180 and client human resources processes that are managed by the server 110. It will be appreciated that while some changes in the law can be implemented automatically by the server, others may require a system administrator to manually implement the change.

The rules module 162 also includes the functionality to track the progress of a client system 120 through a particular human resources process such as, but not limited to, hiring an employee, and to determine whether the client system is complying with or overriding a prescribed sequence for advancing through the process.

The rules module 162 can also include the fuictionality for tracking the privacy laws and for ensuring that the information that is tracked and stored about the clients 120 is not shared or used by the server 110 in violation of the privacy laws.

The status module 164 is configured to monitor and track the status of client applicants, employees, and other client objects that are involved in a human resources process. The status module 164 also includes the functionality to initiate a query for information regarding a particular client party or object. For example, the status module 164 might utilize the communication module 160 to initiate a background check of a client employee from a third party resource 140 or to determine whether an applicant has completed and submitted a requested piece of information.

The status module 164 can also obtain relevant status information from various sources, including the forms and templates 180 that are submitted by the client or that are otherwise provided by the server to the client. The status data of clients can be tracked within the charts 190 and other data structures of the server database 170.

Other modules 168, some of which are described in more detail below, such as the hiring module 169a, training module 169b, employee application module 169c and the compensation module 169d are configured with computer-executable instructions for facilitating legal compliance for various human resources processes, as described herein.

The server database 170 is currently shown to be incorporated within the server system 110. Nevertheless, it will be appreciated that the database 170 can include remote data storage as well as local data storage. Likewise, is will also be appreciated that the database 170 can include any combination or quantity of computer-readable media, including, but not limited to RAM, ROM, EEPROM, CD-ROM, other optical disk storage, magnetic disk storage and magnetic storage devices.

Methods for Managing Human resources Compliance

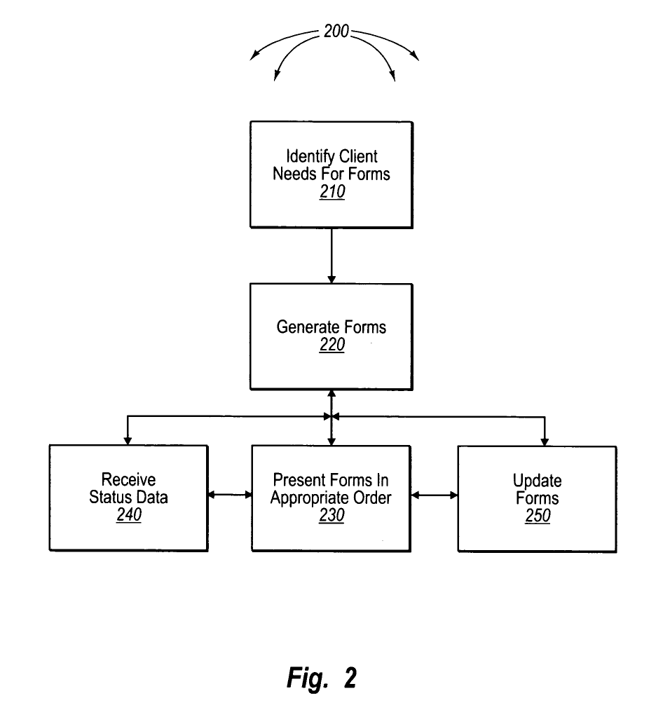

Attention will now be directed to FIG. 2, which illustrates a flowchart 200 of one embodiment of a method for managing human resources compliance. As shown, the method begins with the act of identifying client needs for forms, act 210. The term “form” and “human resources form” should be broadly construed to include any employee form, template, manual or other material that can be used to implement a human resources process. Non-limiting examples of forms include applications, authorizations, requests, disclosures, instruction materials, and training materials.

The act of identifying a client need for a form (act 210) can be accomplished directly, by receiving an explicit request from a client, or indirectly, by determining that a client needs a form based on an evaluation of client characteristics and legal criteria that require a form for implementation of a particular process by the client. The identification of a client need for a form (act 210) can also include identifying a change in a law or the client status that requires a form to be updated or produced for that client.

The appropriate forms are then generated for the client (act 220). According to one embodiment, the generated forms are customized for each client according to the available status information that is currently known about the client and according to the existing legal criteria. For example, if different forms are required for different sized companies, the server generates the appropriate form for that company.

Likewise, the generation of forms (act 220) can also include the auto-completing of the forms with data that is presently known by the server or that is automatically obtained in response to a query. For example, if a form has fields that need to be completed by the client or client employee, that information can be automatically input into the fields on the form when the requested data is already known.

Thereafter, the forms can be presented to the client for their intended purpose, and in compliance with the legal criteria governing the client process (act 230). For example, if a client needs to submit a form to a government agency, that form can be produced and provided to the client for completion. Alternatively, if enough information is known about the client to complete the form, it can be auto-completed and submitted to the client for final approval. Thereafter, the client can submit the form to the appropriate agency. The client may also authorize the server to submit the form, in which case the client can digitally sign the document, as suggested above.

One benefit provided by the present invention is that it not only enables the creation of forms and information for a client that are compliant with the existing state of the law, but it also determines the appropriate order in which the forms and information should be presented, so as to further facilitate compliance with the law. For example, if a client cannot legally perform a background check on an applicant until the client first provides a conditional offer of employment to the applicant, then the server will determine this, based on the existing state of the law, and will dynamically provide the client the opportunity to perform the background check only after the conditional offer has been extended to the applicant.

Many of the client forms generated by the server will request information about the client or client parties (e.g., applicants/employees). This information is referred to herein as “status data.” The term “status data,” should not be construed narrowly. Instead, “status data” should be broadly construed to include any information corresponding to the client or client parties, such as, but not limited to, personalized information (e.g., name, address, birthday, etc.), as well as professional information (e.g., experience, title, position, compensation, etc.). Status data can also be directed to a particular human resources process, such as application status (e.g., complete/incomplete), interview status (e.g., passed/failed), screening status (e.g., passed/failed), offer status (e.g., conditional/accepted/rejected), and so forth.

In one embodiment, status data is received (act 240) in direct response to a query for information when a client or client party completes and submits a form to the server. For example, when a prospective employee fills out an application, either online (e.g., via a client website or a server website) or by paper, and submits the application to the server (e.g,. having it scanned by the server), the server extracts the status data (act 240) from the completed form and stores it for future use. Status data can also be obtained automatically when the server queries a database or system associated with the client, without requiring the client to expressly or manually fill out a form or respond to a specific request. Status data about a client or client party can also be obtained indirectly through a remote third party resource, such as from an investigative agency, credit bureau, and so forth.

Whenever status data is received (act 240) and whenever the current state of the law has changed, there is the possibility that the forms produced for the client either need to be updated (act 250) or presented in a different order to accommodate the change(s).

Accordingly, in one embodiment of the invention, the forms are dynamically updated to accommodate changes in the law. For example, if a change in the law prohibits an employer from requesting information, the rules module 162 will automatically determine whether the change in the law created a conflict with any existing forms. If there is a conflict, the form will automatically be changed to accommodate the new law. For example, in the present case, the prohibited request for information would be stricken from any existing forms so that the client would only be presented with forms that are compliant with the current state of the law.

According to another embodiment, the order in which forms are presented to the client will also change dynamically to accommodate changes in the legal criteria and/or status data received from the client. For example, if a change in a law included a provision requiring all employees to review new training materials, the server would automatically generate the appropriate training materials with a corresponding data structure for tracking the employees training progress.

In another embodiment, notices regarding changes in the law are also generated (e.g., via email or banners) to advise the client of the recent changes and to instruct the client of the steps that should be taken to remain compliant with the new laws. This may require the client to repeat certain steps that have already been performed, such as filling out forms, after the forms have been updated. This embodiment can be particularly useful when considering a change in the law can occur ‘mid-stream,’ after a human resource process has already begun, but prior to its completion.

The training materials could also be customized for each employee, depending on the needs of the client, and could be presented in an electronic format through the Internet, thereby eliminating the need for the client to expend the time and cost associated with reproducing the training materials.

It will be appreciated that in this manner it is possible to reduce or eliminate the need for client human resources departments to individually monitor and track the certain processes. Instead, the client can rely on the server system to effectively implement and monitor training and certain other human resources process.

In each of the forgoing and following examples, a user interface can also be provided to facilitate access to various forms and materials. Access to different data through the interface can also be restricted according to different authorization levels to accommodate virtually any need and preference. The user interface can be provided to the client in various ways. For example, the user interface can be provided to the client through a browser-based application and webpage as well as through direct access.

According to one embodiment, the user interface generally provides access to forms corresponding to different human resources processes. Access to the forms is controlled at least in part by the legal criteria governing the human resources process, as well as the needs of the client. For example, the user interface can restrict a client from accessing a particular form until client status data (e.g., form data) is received and/or until legal criteria for submitting the form has been satisfied. (e.g., providing a conditional offer of acceptance prior to accessing a background check request form).

By way of illustration, and not limitation, the user interface can provide checklists that need to be manually checked off prior to advancing to a different screen of the interface or prior to providing a desired form. In such circumstances, the checklists may require input (e.g., client status data) that indicates a particular task has been completed or that provides a requisite piece of information.

Typically, the user interface provides the forms that are being requested by the client, and at the time they are requested. However, as described above, the availability of the forms, as well as the sequence in which they are provided may be contingent upon receiving input from the client and in a manner that facilitates compliance with any legal standard. Upon receiving client input that is implicitly or explicitly requested by the form, the user interface then proceeds to obtain and display additional forms to be used by the client, and in the appropriate order. For example, the additional forms may include training manuals, hiring packets, or other materials that are customized for a particular process. Customization can be performed, for example, by using the status data and input received from the client.

In another embodiment, the user interface also includes a portion dedicated to reflecting recent changes in the legal criteria that are used to govern the human resources processes. This way, the client can be apprised of relevant changes in the law even though the client may not be involved in the particular stage of a process that is currently being affected by the change in law. The interface can also be used as a medium for requesting and receiving information from the client that can be used to generate or customize a form.

In some embodiments, the interface also provides portions dedicated to enabling the client to generate and/or query tables, charts, and spreadsheets indexing the status date corresponding to the client, the legal criteria corresponding to a human resources process, and status data corresponding to the applicants and employees of the client.

In certain embodiments, as described above, applicants and employees of the client can also obtain limited access to the interface to undergo training, review the current state of the law of a particular processes, access manuals and handbooks, fill out forms, request information, digitally sign documents, and to review their status information.

With general reference to one exemplary implementation of the invention, the user interface can also be used to guide an auto dealer through various step-by-step processes that assure full and timely compliance of the auto dealer with federal and state regulatory requirements and laws in areas such as, but not limited to, applications for employment, hiring, new hires, employee training, employee terminations, retirement, and employer policies.

Managing Legally Compliant Hiring

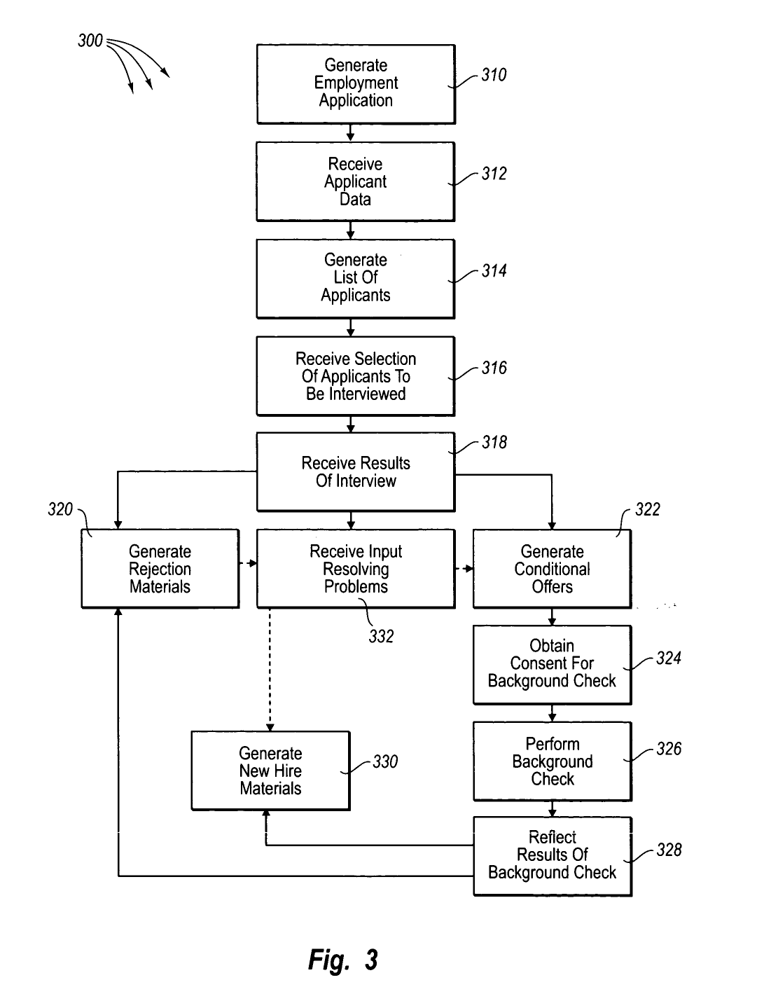

FIG. 3, which will now be described, illustrates a flowchart 300 of a method for an auto dealer, or other entity, to hire employees in a multi-step screening process that includes an application, interview, drug and background checks, and acceptance, and that also provides information concerning such things as the status of the applicant.

The first illustrated act of the present method for hiring an applicant includes the generation of an application (act 310). The generation of an application can include processes previously described above in reference to FIG. 2. The application can then be reproduced for the applicant either in paper form or electronically.

Applicants complete and submit the application. Information used to complete the application is then extracted from the form and stored by the server (act 312). In one embodiment, the applicant data is encrypted or otherwise secured to prevent unauthorized access to, and/or use of, such information. Thereafter, the server generates a list of the applicants (act 314) in any one of a variety of different views requested by the client. The client can access the list of applicants and corresponding applicant data, for example, through the interface described above.

In the event that an applicant is rejected based on their application, for failing to satisfy predetermined criteria, the hiring module 169a automatically populates the appropriate fields in a form rejection letter with information that is extracted from the application submitted by that applicant. The hiring module 169a then automatically prints the letter for mailing to the applicant. The status of the applicant in the applicant database is then automatically updated by the hiring module 169a from ‘pending’ to ‘fail.’

If, on the other hand, if the applicant's application is not rejected, having satisfied predetermined application criteria, the hiring module 169a displays contact information for the applicant, as well as the corresponding job application, and permits the client to print either or both for use during the applicant interview, assuming the applicant has been selected to be interviewed (act 316).

In some embodiments, when the employment application is accepted, the server automatically generates forms, or other communications for notifying the job applicant concerning an interview. The communications generated by the server can include a scheduled time for an interview, or merely inform the applicant of their status as being approved for an interview. In other embodiments, the client customizes the forms generated by the server with appropriate interview scheduling information. The client or the server can then transmit the interview request to the applicant.

Upon completing the interview, the interview results are input into the system by the client (act 318). In the event that the interview is unsuccessful, the hiring module 169a generates and prints an appropriate rejection letter for that applicant (act 320). If, on the other hand, the interview is successful, the hiring module 169a generates and prints a ‘conditional offer’ letter (act 322) and then offers the client the option of authorizing drug screening and background screening for the prospective employee.

In the present embodiment, with specific regard to the background check and drug screening, it will be pointed out that these options are not made available to the client until the conditional offer letters have been generated for the applicant, due to legal criteria governing the hiring of employees. In particular, in one embodiment, the law requires a prospective employer to extend a conditional offer to an applicant prior to conducting a background or drug check on the applicant. Therefore, the server will not provide the client the option of initiating a background/drug check until the client has extended the conditional offer to the applicant.

Accordingly, it will be appreciated that the present invention does more than merely provide legal forms to a client. In particular, the present invention effectively forces compliance of the law for human resources processes by providing legally compliant forms to a client and in the order that is determined at least in part by the legal criteria governing the process.

With regard to background checks, drug tests and other such screenings, the hiring module 169a generates all the forms that are used by the prospective employee to authorize the client to perform drug and background checks concerning that applicant. The hiring module 169a then prints out all legally required documents that are necessary to authorize and conduct such drug screening and background screening. Requests and authorizations for background screenings can also be submitted electronically.

Upon obtaining consent for the background and/or drug check (act 324), the server performs the test (act 326) through an authorized entity, such as a third party resource, as described above in reference to FIG. 1.

The results of the background test are then logged into the system (act 328). If the applicant fails the background screening process, the hiring module 169a generates and prints an appropriate rejection letter (act 320). The hiring module 169a also generates and prints all the legally mandated documents, as well as a letter of intent not to hire the applicant. If there is a rule or regulation that requires the applicant be given a chance to challenge the results of the screening or if there is another way in which the applicant can resolve the problems associated with their hire, then the hiring module 169a can also incorporate those options into the system (act 332).

Finally, the hiring module 169a records whether or not the applicant accepts the conditional offer and, if the applicant accepts, establishes him/her as a newly hired employee. At this point, the hiring module 169a of the application automatically populates required information about the newly hired employee into the various documents required by state, federal, and/or other authorities. These documents, and a checklist, are then printed for review, completion and signing by the newly hired employee (act 330). The employee is then granted access to an appropriate orientation and training module 169b that makes various employer documents, such as an employee handbook, available to the employee for study, testing and electronic signature.

At least some embodiments of the invention employ a training module 169b that also includes a training program for use in ensuring compliance of the company and/or its employees with various applicable Federal Trade Commission rules and regulations, an example of which is the ‘Safeguards Rule’ posted at www.fic.gov/privacy/glbact.

Other aspects of the aforementioned Safeguards Rule that are implemented in connection with exemplary embodiments of the invention related to customer information security (“CIS”). In particular, some embodiments of the invention provide various online tools that can be accessed through the interface, to facilitate administration of hiring and related processes and to facilitate compliance of such processes with the provisions of the Safeguards Rule and other applicable rules.

Examples of such online tools include, but are not limited to, a ‘Policy Tab’ (addresses legal requirements and aids in development of standard corporate CIS policy), ‘CIS Tab’ (includes client CIS questionnaire, CIS report, and related materials), ‘Training Tab’ (client can access and administer CIS training for employees), ‘Report Tab’ (client can use a training report generator for CIS training), ‘Toolkit Tab’ (includes CIS program coordinator job description, and CIS contracts and agreements with service providers), and a ‘Legal Tab’ (further legal matters concerning CIS).

Other CIS tools include automated safeguards assessment and compliance tools that generate automatic reports identifying what the client and/or a client employee needs to do to become compliant with a particular rule. The assessment of compliance can include the use of questionnaires or other data collection techniques to identify a current state of compliance of the client, client activity, or client employee. The identified state of compliance is then compared with one or more existing rules of law, such as, for example, through the use of the rules module described above.

If it is determined that a client or a client employee is out of compliance, the user interface can be used to notify the client of noncompliance. The client can also be notified of compliance. The notifications of compliance/noncompliance can be provided through displays or emails that are made available to the client at any point upon accessing their account through the user interface. It will be appreciated that the notifications of compliance/noncompliance can be any combination of generalized and detailed reports corresponding to any number of employees and client activities. Various additional and alternative tools can also be implemented as well to provide the client access to information regarding compliance, consistent with the requirements of a particular application.

Notwithstanding the specificity of the foregoing examples, it will be appreciated that other types of human resources processes can also be managed according to implementations of the invention, including, but not limited to, compensation, vacation, medical leave, benefits, transfers, retirements and terminations. In particular, different modules or sub-modules can be created and combined with the modules already illustrated and described in FIG. 2.

One functional module employed in connection with some embodiments of the invention is an employee application module 169c, for use in combination with the hiring module 169a described above in reference to FIG. 3. The employee application module 169c, for example, enables prospective employees to apply for jobs online, that is, by way of an internet website, and also provides links to the website of an employer, as well as links to various job boards and online job application services. Exemplarily, the employee application module 169c uses on-line job application forms that substantially reflect the ‘California Motor Car Dealers Association Form Source’ employment application, as may be amended from time to time. Of course, any other type of job application form may be employed as well. Access to the on-line job application form is available to any computer user with web, or Internet, access through a suitable web browser. The employee application module 169c also permits the use of electronic signatures and facilitates storage of the signed applications. The service subscriber, a car dealer in this example, can then access and view the completed applications whenever it is desired to fill a particular position.

Other examples of modules 168 that can be implemented with the present invention include, but are not limited to, vacation modules, termination modules, promotion modules, sick leave modules, insurance modules, retirement modules, and training module 169b, for determining when and how to manage corresponding human resources processes in compliance with the law.

Managing Employee Compensation

A final example of a module that can be implemented with the present application is a compensation module 169d to calculate the ideal standard of pay to use for compensating employees in compliance with the law and according to the needs of the company. The compensation module 169d can be configured to track employee base pay, rewards, incentives and other forms of compensation.

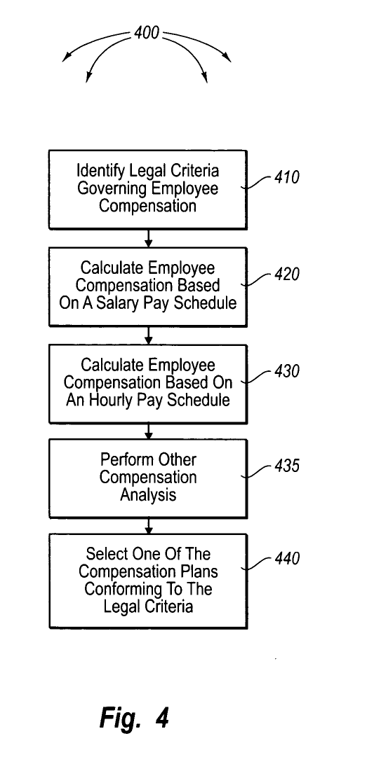

The compensation module 169d can also calculate employee compensation based on different legally permissible standards that are continuously updated by the rules module 162. The compensation module 169d can then determine and recommend a preferred standard of compensation to use for one or more employees, based on the current state of the law and the needs of the client. In some embodiments, for example, the compensation module can be optimized by an employer to minimize the total amount of compensation they have to pay out within the established guidelines of the law. One embodiment of the compensation module 169d is described with specific reference to the method illustrated by the flowchart 400 of FIG. 4.

As shown in FIG. 4, the illustrated method for compensating an employee includes the initial act of identifying the legal criteria governing employee compensation (act 410). These criteria can be obtained from various third party resources, including federal, state and local agencies. Next, the method includes calculating employee compensation based on different legally permissible standards, such as, but not limited to compensation based on a salary pay schedule (act 420), compensation based on an hourly pay schedule (act 430), and/or compensation based on any other compensation analysis (act 435), such as, but not limited to fluctuating work week analysis, overtime exemption analysis, and minimum wage analysis. The other compensation analysis can be used to determine a desirable compensation for compensating an employee that is paid on any combination of commission, flat-rate and other compensation plans.

It will be appreciated however, that inasmuch as there can be any number of different standards by which compensation can be calculated, the present invention is not limited to the calculation of compensation based exclusively on hourly or salary standards.

Some non-limiting examples of the types of analysis and consideration that can be used to calculate employee compensation are reflected in the following two worksheets which correspond to monthly pay with overtime for commission salespersons (Worksheet I) and pay with overtime for flat-rate service technicians (Worksheet II).

Worksheet I

Monthly Pay with Overtime Worksheet for Commission Salespersons

(1) Total Wages (add lines 1a, 1b and 1c) $ ______

(1a) Commission Wages $ ______

(1b) Non-Commission, Non-Salary Wages (Spiffs, Bonus, etc.) $ ______

(1c) Salary Wages $ ______

(1d) Total Non-Commission Wages (add Lines 1b and 1c) $ ______

(1e) Total Non-Salary Wages (add Lines 1a and 1b) $ ______

Overtime Exemption Analysis

(2) Total Hours Worked (add Lines 4 and 5) ______

(3) Exempt Base (Multiply Line 2 by×1.5 Minimum Wage: ($ ) $ ______

(3a) If Line 1a is less than or equal to Line 1d, then skip to Line 4.

(3b) If Line 1 is greater than or equal to Line 3, then enter the amount from Line 1 in Line 15 and proceed to Line 16.

Fluctuating Work Week Analysis

(4) Straight Time Hours Worked ______

(5) Total Overtime Hours Worked (add Line 5a and 5b) ______

(5a) Overtime Hours Worked at 1.5× rate based on hours worked during each work week of the month ______

(5b) Overtime Hours Worked at 2× rate based on hours worked during each work week of the month ______

(6a) Divide Line 1e by Line 2 $ _______

(6b) Divide Line 1c by 173.33 (number of hours in an equal-length month) $ ______

(7) Divide Line 6a by 2 $ ______

(8) Total of Lines 8a through 8d $ ______

(8a) Multiply Line 7 by Line 5a $ ______

(8b) Multiply Line 6a by Line 5b $ ______

(8c) Multiply Line 6b by Line 5a by 1.5 $ ______

(8d) Multiply Line 6b by line 5b by 2 $ ______

(9) Total compensation Due if Non-Exempt (add Line 8 and 1) $ ______

Minimum Wage Base Analysis

(10) Multiply Line 4 by Minimum Wage ($ ) $ ______

(11a) Multiply Line 5a by 1.5 Minimum Wage ($ ) $ ______

(11b) Multiply Line 5b by 2× Minimum Wage ($ ) $ ______

(12) Minimum Wage Base (add Line 10, 11a and 11b) $ ______

(12a) If Line 12 is greater than or equal to Line 9, then enter the amount from Line 12 in Line 15 and proceed to Line 16.

Fluctuating Work Week vs. Overtime Exemption Analysis

(13) Subtract Line 1 from Line 3 $ ______

(14) Subtract Line 1 from Line 9 $ ______

(14a) If Line 1a is greater than Line 1d, and Line 13 is less than or equal to Line 14, then enter the total from Line 3 in Line 15 and proceed to Line 16.

(14b) If Line la is less than or equal to Line 1d, or Line 13 is greater than Line 14, then enter the amount from Line 9 in Line 15 and proceed to Line 16.

(15) Total Earnings $ ______

(16) Amount of wages already paid to employee during the month (spiffs, bonuses, draws, advances, commissions, salary, etc. $ ______

(17) Subtract Line 16 from Line 15. Pay this amount $ ______

Worksheet II

Pay with Overtime Worksheet for Flat-Rate Service Technicians

(1) Total Wages (total of 1a and 1b) $ ______

(1a) Total Flat-Rate Pay $ ______

(1b) Total bonuses and spiffs $ ______

(1c) Total hours worked during period for which bonus amount in line 1b applies—i.e., total hours for month if bonus applies to whole month; total hours for week if bonus applies only to the week, etc.

Fluctuating Work Week Analysis

(2) Total Hours Worked (add Line 3 and 4)

(3) Straight Time Hours Worked

(4) Total Over time Hours Worked (total of 4a and 4b)

(4a) Overtime Hour Worked at 1.5× rate

(4b) Overtime Hours Worked at 2× rate

(4c) Overtime Hours Worked at 1.5× rate during period for which amount in Line 1b applies; during the entire month if bonus applies to whole month, during the week if bonus applies only to the week, etc. ______

(4d) Overtime Hours Worked at 2× rate during period for which amount in Line 1b applies; during the entire month if bonus applies to whole month, during the week if bonus applies only to the week, etc. ______

(5a) If Line 2 is zero, enter zero; otherwise divide Line 1a by Line 2 $ ______

(5b) If Line 1c is zero, enter zero; otherwise divide Line 1 by Line 1c $ ______

(6a) Divide Line 5a by 2 $ ______

(6b) Divide Line 5b by 2 $ ______

(7) Total Overtime Due (total of 7a through 7d) $ ______

(7a) Multiply Line 6a by Line 4a $ ______

(7b) Multiply Line 5a by Line 4b $ ______

(7c) Multiply Line 6b by Line 4d $ ______

(7d) Multiply Line 5b by Line 4d $ ______

(8) Total Compensation Due (add Line 7 and Line 1) $ ______

Minimum Wage Base Analysis

(9) Multiply Line 3 by Minimum Wage ($ ) $ ______

(10) Multiply Line 4a by 1.5× Minimum Wage ($ ) $ ______

(11) Multiply Line 4b by 2× Minimum Wage ($ ) $ ______

(12) Minimum Wage Base (add Line 9, 10 and 11) ($ ) $ ______

(13) Multiply Line 2 by Minimum 2× Wage ($ ) $ ______

(14) Is the technician required to provide his/her own tools? ______

(14a) If the Technician is required to provide his/her own tools, then enter the greater of Line 8 or Line 13 in Line 15 for amount to pay employee.

(14b) If the technician is not required to provide his/her own tools, then enter the greater of Line 8 or Line 12 in Line 15 for amount to pay employee.

(15) Pay this amount $ ______

It will be appreciated that the calculation of compensation according to a variety of different legally permissible standards can be particularly beneficial in the sales industry where employees are sometimes rewarded with special incentives, beyond their base pay, for meeting goals or achieving certain levels of performance.

For example, in some circumstances within the sales industry, the calculations required to determine the regular rate of pay, to see whether an employee is overtime exempt, must account for the special incentives the employees receive in addition to their base pay. Accordingly, depending on the current state of the law and the particular performance of an employee, it might be better for a business to compensate an employee with a salary, instead of paying the employee based on an hourly rate.

Therefore, by providing a module for automatically calculating the compensation for employees according to different legally permissible standards (acts 420 and 430), while at the same time accounting for different incentives and rewards received by the employee, it will be easy for an employer to verify that they are complying with the law and to select the best compensation plan to use (act 440) according to the needs of the company. This is particularly true when considering the situation in which an employee works overtime and the calculation for overtime pay is dependent upon all or only a part of the total compensation received by the employee.

In summary, embodiments of the invention are configured to limit the likelihood of deviation from a defined ideal process pathway. More particularly, embodiments of the invention are configured to include or reference, and develop outputs that conform to, any and all applicable human resources rules, statutes, regulations and guidelines. Subscribers are notified when such rules or regulations have changed such as, for example, through a user interface, but such changes typically require little or no action on the part of the subscriber, as the service is automatically updated to accommodate such changes. Thus, the subscriber can be assured that its actions in regard to human resources issues are always in compliance with the applicable human resources rules, statutes, regulations and guidelines. In this way, the human resources overhead costs of the subscriber are substantially reduced, as is the likelihood that the subscriber will run afoul of the governing laws and regulations. The savings thus realized in terms of times and money can then be redirected to other aspects of the business.

Although certain aspects of the invention have been described as being implemented in connection with a subscription service accessible by one or more clients, such as by way of a service provider internet site, it will be appreciated that at least some aspects of the invention can also be implemented as a stand-alone software package that is suitable for installation on one or more of the client systems, and without having to access a server internet site after installation. More generally, the application may be implemented in any other form consistent with the functionality disclosed herein and with the requirements of the applicable business model.

Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a client-server environment, a method for facilitating the management of human resources compliance efforts, the method comprising:
generating a plurality of human resources compliance forms that substantially conform to predetermined legal criteria;
making the plurality of human resources compliance forms available to a client and in an order that is dynamically controlled at least in part by the legal criteria and status data corresponding to the client;
updating, as required, at least one of the plurality of human resources compliance forms to conform with a change in the legal criteria; and
making the updated human resources compliance form available to the client.

2. A method as recited in claim 1, wherein the plurality of human resources compliance forms includes:
a first rejection letter form;
a second rejection letter form;
a conditional acceptance letter form;
a drug screening authorization form;
background screening authorization form;
a third rejection letter form;
an intent-not-to-hire letter form; and
a new hire document.

3. A method as recited in claim 1, wherein the predetermined legal criteria and human resources compliance forms correspond to employee hiring.

4. A method as recited in claim 1, wherein the predetermined legal criteria and human resources compliance forms correspond to employee termination.

5. A method as recited in claim 1, wherein the predetermined legal criteria and human resources compliance forms correspond to employee training.

6. A method as recited in claim 1, wherein the predetermined legal criteria and human resources compliance forms correspond to employee compensation.

7. A method as recited in claim 1, wherein the status data corresponds to at least one of a client characteristic and an employee of the client.

8. A method as recited in claim 7 wherein generating the human resources compliance forms includes receiving the status data from the client.

9. A method as recited in claim 7, wherein the status data is received from a third party.

10. A method as recited in claim 7, wherein the status data is received from a third party resource.

11. A computer program product for use in a client-server environment, the computer program product comprising one or more computer-readable media having computer-executable instructions for implementing a method for facilitating the management of human resources compliance efforts, the method comprising:
generating a plurality of human resources compliance forms that substantially conform to predetermined legal criteria,
making the plurality of human resources compliance forms available to a client and in an order that is dynamically controlled at least in part by the legal criteria and status data corresponding to the client;
updating, as required, at least one of the plurality of human resources compliance forms to conform with a change in the legal criteria; and
making the updated human resources compliance form available to the client.

12. In a client-server environment, a method for managing human resources compliance, the method comprising:
receiving an employment application from a job applicant;
accepting the employment application if information provided in the employment application meets predetermined criteria, otherwise, rejecting the employment application;
accessing at least one of a plurality of human resource compliance forms that substantially conforms to predetermined legal criteria,
automatically generating, a first rejection letter by populating at least one data field of the first rejection letter form with information extracted from the employment application, if the employment application is rejected;
notifying the job applicant concerning a job interview, if the employment application is accepted;
automatically generating a second rejection letter by populating at least one data field of the second rejection letter form with information extracted from the employment application, if the job interview is unsuccessful;
automatically generating a conditional acceptance letter by populating at least one data field of the conditional acceptance letter form with information extracted from the employment application, if the job interview is successful;
automatically populating at least one field of each of the drug and background screening authorization forms with information extracted from the employment application;
automatically generating a third rejection letter by populating at least one data field of the third rejection letter form with information extracted from the employment application, if the drug screen or background screen is unsuccessful;
automatically generating an intent-not-to-hire letter by populating at least one data field of the intent-not-to-hire letter form with information extracted from the employment application, if the drug screen or background screen is unsuccessful; and
automatically populating at least one field of the new hire document if the drug screen and background screens are successful and the job applicant is hired.

13. A method as recited in claim 12, wherein the plurality of human resource compliance forms includes:
first, second and third rejection letter forms;
a conditional acceptance letter form;
drug and background screening authorization forms;
an intent-not-to-hire letter form; and
a new hire document.

14. A method as recited in claim 12, wherein the application is received in an electronic format.

15. In a client-server environment, a user interface provided by a server for facilitating the management of human resources compliance efforts, the user interface comprising:
a first interface portion configured to provide a client access to a plurality of forms for use in a human resources process, wherein client access to the forms is controlled at least in part by legal criteria governing the human resources process, and wherein at least one of the forms is dynamically updated by the server to reflect changes in the legal criteria;
a second interface portion configured to reflect changes in the legal criteria; and
a third interface portion configured to reflect status data of employees working for the client, the at least one updated form being customized for at least one of the employees based on the status of the at least one employee.

16. A user interface as recited in claim 15, wherein client access includes the ability of the client to modify data used to populate fields on the forms.

17. A user interface as recited in claim 15, wherein the forms are customized according to client characteristics.

18. A user interface as recited in claim 15, further including an interface portion configured to display training materials and to track training progress.

19. In a server system that is in communication with a client system and that has a user interface and access to a store of human resources forms, a method for facilitating management of human resources compliance efforts, the method comprising:
receiving a request from a client to access at least one of a plurality of human resources forms available to the server system;
displaying the requested at least one human resources forms at the client system, the requested at least one human resources forms requesting client status data;
receiving client status data that is entered on the at least one human resources forms at the client system; and
displaying at least one additional human resources forms in an order that is dynamically controlled at least in part by a legal criteria and the entered client status data, at least one of the receiving and displaying processes being performed in connection with the user interface.

20. A method as recited in claim 19, further including updating the at least one human resources forms or the at least one additional human resources forms in response to a change in the legal criteria.

21. A method as recited in claim 20, further including generating and displaying a notice at the client system that notifies the client of the change in the legal criteria.

22. A method as recited in claim 19, wherein the requested client status data comprises input regarding an applicant for hire.

23. A method for managing human resources compliance for employee compensation, the method comprising:
identifying different legally permissible compensation plans according to legal criteria governing employee compensation;
for a single employee, calculating different employee compensations based on the different legally permissible compensation plans, the different legally permissible compensation plans including:
at least a first compensation plan based on a salary pay schedule; and
at least a second compensation plan based on an hourly rate pay schedule; and
selecting one of the compensation plans conforming to the legal criteria and client needs.

24. A method as recited in claim 23, wherein calculating different employee compensations includes calculating a regular rate of pay accounting for special incentives received by the employee in addition to a base pay.

25. A method as recited in claim 24, wherein the selection of one of the compensation plans is based at least in part on whether an employee is overtime exempt under the selected plan.

26. A method as recited in claim 23, wherein calculating different employee compensations further includes performing compensation analysis.

27. A method as recited in claim 26, wherein the compensation analysis is used to determine a desirable compensation for compensating an employee that is paid on commission.

28. A method as recited in claim 26, wherein the compensation analysis is used to determine a desirable compensation for compensating an employee that is paid by a flat-rate.
